(19) United States
(12) Patent Application Publication
(10) Pub. No.: US 2023/0300922 A1
(43) Pub. Date: Sep. 21, 2023

(54) WIRELESS CONNECTIVITY IN A MULTI-NETWORK ENVIRONMENT

(71) Applicant: Charter Communications Operating, LLC, St. Louis, MO (US)

(72) Inventor: Saran Khalid, Denver, CO (US)

(21) Appl. No.: 17/586,005

(22) Filed: Jan. 27, 2022

(51) Int. Cl. H04W 76/15; H04W 36/06; H04L 43/0894

(52) U.S. Cl. CPC H04W 76/15; H04L 43/0894; H04W 36/06

(57) ABSTRACT

A wireless network environment includes communication management hardware, a wireless base station, a core network, and multiple remote networks. The communication management hardware establishes first wireless connectivity between customer premises equipment and a main wireless base station. The customer premises equipment provides one or more communication devices in a subscriber domain access to a remote network over the first wireless connectivity and through the main wireless base station. A mobile communication device unaffiliated with the subscriber domain may be located inside or outside the subscriber domain. The main wireless base station provides the mobile communication device connectivity to the remote network. In response to receiving notification to operate the customer premises equipment in a supplemental wireless base station mode, the customer premises equipment provides the mobile communication device access to the remote network through the customer premises equipment.

### BACKGROUND

Conventional wireless systems support different types of wireless connectivity. For example, conventional wireless systems support so-called fixed wireless access (FWA) connectivity between a wireless base station and so-called customer premises equipment. In general, fixed wireless access is sometimes a cost effective option to provide broadband wireless services in rural areas requiring minimal equipment and effort to install compared to alternative implementations including hardwired networks (such as coaxial cable, optical fiber, etc.).

### BRIEF DESCRIPTION OF EMBODIMENTS

Embodiments herein provide improved implementation of wireless access networks and expand use of limited wireless bandwidth in a network environment.

More specifically, communication management hardware such as associated with customer premises equipment (a.k.a., wireless access point, wireless station, etc.) establishes first wireless connectivity with a first wireless base station in a network environment. The customer premises equipment provides one or more communication devices in a subscriber domain access to a remote network over the first wireless connectivity and through the first wireless base station. In response to receiving notification (such as a command) to operate the customer premises equipment in a supplemental wireless base station mode with respect to the first wireless base station and support of the communication devices in the subscriber domain, the customer premises equipment provides a mobile communication device located outside of the subscriber domain access to the remote network through the customer premises equipment.

In further example embodiments, the customer premises equipment provides the mobile communication device access to the remote network through the customer premises equipment via establishing second wireless connectivity between the customer premises equipment and the mobile communication device. In such an instance, the customer premises equipment receives first communications over the first wireless connectivity from the wireless base station; the first communications originate from the remote network. The customer premises equipment transmits the first communications from the customer premises equipment over the second wireless connectivity to the mobile communication device.

In a reverse direction, the customer premises equipment receives second communications from the mobile communication device over the second wireless connectivity. In one embodiment, the mobile communication device originates the second communications. The customer premises equipment transmits the second communications over the first wireless connectivity to one or more different destinations in the remote network.

In further example embodiments, the customer premises equipment or other suitable entity monitors a collective bandwidth service provided by the first wireless connectivity to the one or more communication devices in the subscriber domain. The customer premises equipment may share a portion of bandwidth to support the second wireless connectivity. However, the customer premises equipment can be configured to prevent the collective bandwidth service associated with the communication devices in the subscriber domain from falling below a threshold level. For example, in one embodiment, the customer premises equipment limits an amount of wireless bandwidth associated with the first wireless connectivity supporting communications between the foreign mobile communication device and the remote network.

In still further example embodiments, the customer premises equipment or other suitable entity equipment scans use of wireless channels at a location where the customer premises equipment resides. Based on the scanning, the customer premises equipment determines a degree of usage associated with each of multiple wireless channels. In one embodiment, the customer premises equipment communicates scanning information associated with the monitored wireless channels to an allocation management resource. A communication management resource selects an appropriate wireless channel for use by the customer premises equipment. The customer premises equipment receives selection of a wireless channel amongst the wireless channels from the allocation management resource. Via the selected wireless channel, the customer premises equipment establishes the second wireless connectivity between the customer premises equipment and the mobile communication device to provide the mobile communication device access to the remote network over the second wireless connectivity and the first wireless connectivity.

Further embodiments herein include, via the customer premises equipment or other suitable entity, establishing a heartbeat channel between the customer premises equipment and a spectrum access system controlling use of the selected wireless channel. If no incumbent user uses the select wireless channel, the customer premises equipment provides continued use of the selected wireless channel to support the second wireless connectivity with the mobile communication device in response to repeatedly receiving grant notifications from the spectrum access system (or other suitable entity) allowing continued use of the second wireless connectivity by the customer premises equipment. In one embodiment, the customer premises equipment receives the grant notifications from the spectrum access system over the first wireless connectivity.

Still further example embodiments herein include, at the customer premises equipment, receiving communication control information over the first wireless connectivity from the wireless base station. The communication control information indicates to operate in the supplemental wireless base station mode via establishing second wireless connectivity between the customer premises equipment and the mobile communication device. In one embodiment, the communication control information specifies an identity of the mobile communication device in which to provide connectivity to the remote network via the second wireless connectivity and the first wireless connectivity.

In yet further example embodiments, the customer premises equipment is a fixed wireless access point providing the one or more communication devices in the subscriber domain and the mobile communication device outside the subscriber domain access to the remote network over the first wireless connectivity.

In still further example embodiments, the wireless base station initially supports a communication session between the wireless base station and the mobile communication device; the communication session includes a control plane supporting conveyance of control information. The communication session includes a first data plane supporting conveyance of data payload information; the control information controls conveyance of the data payload information over the data plane. The customer premises equipment can be configured to receive a handoff of the first data plane from the wireless base station to the customer premises equipment.

Further embodiments herein include, via the customer premises equipment, establishing the second wireless connectivity between the customer premises equipment and the mobile communication device based on a handoff of the mobile communication device from the first wireless base station to the customer premises equipment. The initial wireless connectivity between the mobile communication device and the wireless base station includes first control plane connectivity and first data plane connectivity. Subsequent to handoff, the communication session with the mobile communication device is supported via: i) the first control plane connectivity directly between the wireless base station and the mobile communication device, and ii) a second data plane supported via communications over a combination of the first wireless connectivity and the second wireless connectivity, the second data plane being a substitute of the first data plane to support the handoff.

Further embodiments herein include a complete handoff of wireless connectivity to the customer premises equipment such that supplemental wireless connectivity between the customer premises equipment the mobile communication device supports both uplink and downlink communications through the customer premises equipment and wireless base station with respect to the remote network.

Embodiments herein are useful over conventional techniques. For example, customer premises equipment supports supplemental wireless connectivity of one or more mobile communication device (i.e., wireless stations) through the customer premises equipment to a wireless base station via novel signaling and wireless connectivity. In such an instance, a mobile communication device may be out of range or near out of range with respect to a wireless base station or may be better served by the customer premises equipment to access a respective remote network. As discussed herein, the customer premises equipment (such as fixed wireless access point) provides supplemental wireless connectivity providing a respective mobile communication device with a remote network.

Note that any of the resources as discussed herein can include one or more computerized devices, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon. The instructions, when executed by the computer processor hardware, cause the computer processor hardware (such as one or more co-located or disparately processor devices or hardware) to: establish first wireless connectivity between the customer premises equipment and a wireless base station; provide one or more communication devices in a subscriber domain access to a remote network over the first wireless connectivity and through the wireless base station; and in response to receiving notification to operate the customer premises equipment in a supplemental wireless base station mode, provide a mobile communication device located outside of the subscriber domain access to the remote network through the customer premises equipment.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of providing improved wireless connectivity in a network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating collection and distribution of performance data associated with wireless connectivity in a wireless network environment according to embodiments herein.

FIG. 2 is an example diagram illustrating the inability of or degradation associated with a mobile communication device to communicate at a high level of quality with a respective wireless base station and implementation of customer premises equipment in a network environment according to embodiments herein.

FIG. 3 is an example diagram illustrating notification of a nearby mobile communication device and respective notification by a communication management resource to operate customer premises equipment in a wireless channel scan mode according to embodiments herein.

FIG. 4 is an example diagram illustrating operation of customer premises equipment in a scan mode to generate respective wireless channel scan information and communication of the wireless channel scan information to a remote management resource according to embodiments herein.

FIG. 5 is an example diagram illustrating operation of respective customer premises equipment in a supplemental base station mode providing wireless connectivity to a mobile communication device and communication devices in a subscriber domain according to embodiments herein.

FIG. 6 is an example diagram illustrating communication flow amongst multiple entities in a wireless network to support connectivity of a nearby mobile communication device through a customer premises equipment operating in a supplemental base station mode according to embodiments herein.

FIG. 7 is an example diagram illustrating communication flow amongst multiple entities in a wireless network to support connectivity through a customer premises equipment operating in a supplemental base station mode according to embodiments herein.

FIG. 8 is an example diagram of a network environment and implementation of customer premises equipment in a relay mode according to embodiments herein.

FIG. 9 is an example diagram illustrating example computer hardware and software operable to execute operations according to embodiments herein.

FIG. 10 is an example diagram illustrating a method according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DESCRIPTION OF EMBODIMENTS

A wireless network environment includes communication management hardware, a wireless base station, a core network, and multiple remote networks. The communication management hardware establishes first wireless connectivity between customer premises equipment and a main wireless base station. The customer premises equipment provides one or more communication devices in a subscriber domain access to a remote network over the first wireless connectivity and through the main wireless base station. A mobile communication device unaffiliated with the subscriber domain may be located inside or outside the subscriber domain. The main wireless base station initially provides the mobile communication device connectivity to the remote network. In response to receiving notification to operate the customer premises equipment in a supplemental wireless base station mode, the customer premises equipment provides the mobile communication device access to the remote network through the customer premises equipment.

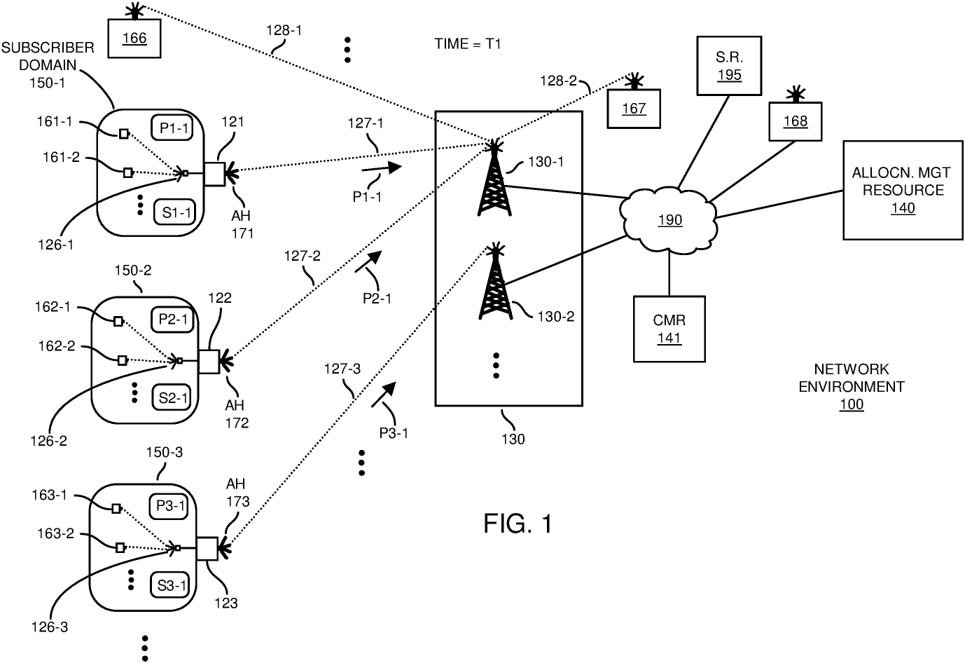

Now, with reference to the drawings, FIG. 1 is an example diagram illustrating wireless connectivity as well as collection and distribution of performance data associated with the wireless connectivity in a wireless network environment according to embodiments herein.

In this example embodiment, the network environment 100 includes multiple subscriber domains 150 (such as subscriber domain 150-1, subscriber domain 150-2, subscriber domain 150-3, etc.), wireless network 130 (including one or more main wireless base station 130-1, main wireless base station 130-2, etc.), communication management resource 140, and control management resource 141.

Note that any of the resources as discussed herein can be implemented as hardware, software, or a combination of hardware and software. For example, the wireless access point 121 can be configured as wireless access point hardware, wireless access point software, or a combination of wireless access point hardware and wireless access point software; wireless base station 130-1 can be configured as wireless base station hardware, wireless base station software, or a combination of wireless base station hardware and wireless base station software; communication management resource 141 can be configured as communication management hardware, communication management software, or a combination of communication management hardware and communication management software; and so on.

Each of the subscriber domains 150 includes wireless equipment providing one or more mobile communication devices wireless access to a remote network 190.

For example, wireless access point 121 (a.k.a., customer premises equipment, wireless station, etc.) in subscriber domain 150-1 includes antenna hardware 126-1 and antenna hardware 171. Via the antenna hardware 171, the wireless access point 121 is in communication with the (main) wireless base station 130-1 over wireless link 127-1 and provides wireless connectivity (such as via any suitable wireless communication protocol including WiFi ®, LTE or Long Term Evolution, etc.) to mobile communication devices 161-1, 161-2, etc. For example, the wireless access point 121 in subscriber domain 150-1 includes antenna hardware 126-1 to communicate with each of the mobile communication devices 161 (e.g., mobile communication device 161-1, mobile communication device 161-2, etc.). Wireless access point 121 (such as customer premises equipment including communication manager hardware, communication management software, or a combination of communication manager hardware and communication management software) includes communication processing hardware and software and provides a communication pathway between antenna hardware 126-1 and antenna hardware 171. Antenna hardware 171 supports connectivity of the wireless access point 121 over wireless communication link 127-1 to the wireless base station 130-1. Thus, via a respective wireless communication link with the antenna hardware 126-1, each of the mobile communication devices 161 are in communication with the wireless access point 121 and additionally through the wireless communication link 127-1 and the wireless base station 130-1 to remote network 190.

Wireless access point 122 (a.k.a., customer premises equipment, wireless station, etc.) in subscriber domain 150-2 includes antenna hardware 126-2 and antenna hardware 172. Via the antenna hardware 172, the wireless access point 122 is in communication with the wireless base station 130-1 over wireless link 127-2 and provides wireless connectivity (such as via any suitable wireless communication protocol including WiFi ®, LTE or Long Term Evolution, etc.) to mobile communication devices 162-1, 162-2, etc. For example, the wireless access point 122 in subscriber domain 150-2 includes antenna hardware 126-2 to communicate with each of the mobile communication devices 162 (e.g., mobile communication device 162-1, mobile communication device 162-2, etc.). Wireless access point 122 includes any suitable resources such as communication processing hardware and software and provides a communication pathway between antenna hardware 126-2 and antenna hardware 172. Antenna hardware 172 supports connectivity over wireless communication link 127-2 to the wireless base station 130-1. Thus, via a respective wireless communication link with the antenna hardware 126-2, each of the mobile communication devices 162 in the subscriber domain 150-2 is in communication with the wireless access point 122 and through the wireless communication link 127-2 and the wireless base station 130-1 to remote network 190.

Wireless access point 123 (a.k.a., customer premises equipment, wireless station, etc.) in subscriber domain 150-3 includes antenna hardware 126-3 and antenna hardware 173. Via the antenna hardware 173, the wireless access point 123 is in communication with the wireless base station 130-2 over wireless link 127-3 and provides wireless connectivity (such as via any suitable wireless communication protocol including WiFi ®, LTE or Long Term Evolution, etc.) to mobile communication devices 163-1, 163-2, etc. For example, the wireless access point 123 in subscriber domain 150-3 includes antenna hardware 126-3 to communicate with each of the mobile communication devices 163 (e.g., mobile communication device 163-1, mobile communication device 163-2, etc.). Wireless access point 123 includes communication processing hardware and software and provides a communication pathway between antenna hardware 126-3 and antenna hardware 173. Antenna hardware 173 supports connectivity over wireless communication link 127-3 to the wireless base station 130-2. Thus, via a respective wireless communication link with the antenna hardware 126-3, each of the mobile communication devices 163 is in communication with the wireless access point 121 and through the wireless communication link 127-3 and the wireless base station 130-2 to remote network 190.

In one nonlimiting example embodiment, each of the one or more of the wireless stations 121, 122, 123, etc., is disposed at a respective fixed location in a subscriber domain. In such an instance, the wireless station 121 (such as fixed wireless access customer premises equipment) is a first fixed wireless station supporting first fixed wireless access to the mobile communication devices 161 (a.k.a., user equipment) in subscriber domain 150-1; the wireless station 122 is a second fixed wireless station (such as fixed wireless access customer premises equipment) supporting second fixed wireless access to the mobile communication devices 162 (such as user equipment) in subscriber domain 150-2; the wireless station 123 is a third fixed wireless station supporting third fixed wireless access to the mobile communication devices 163 (such as user equipment) in subscriber domain 150-3; and so on.

As previously discussed, each wireless station (such as customer premises equipment) provides connectivity (such as fixed wireless access connectivity) between the subscriber domain and corresponding equipment such as mobile communication devices to wireless network 130.

Assume that the mobile communication device 161-1 generates a request to retrieve respective content such as a webpage from server resource 195 (or other destination) or connect (such as establish a phone call connection) with mobile communication device 168 or other suitable entity. To this end, in an upstream (uplink) direction, mobile communication device 161-1 operated by a respective user transmits communications (such as a content or other type of request) over a respective wireless communication link in subscriber domain 150-1 to the wireless access point 126-1; the wireless station 121 processes and transmits the communications received from the mobile communication device 161-1 over the wireless communication link 127-1 to the wireless base station 130-1; wireless base station 130-1 transmits the communications (such as a request for content) over network 190 to the server resource 195 or mobile communication device 168 (destination address identified by the request).

In a downstream direction, in response to receiving a request for content, the server resource 195 (or other entity in network 190) communicates the requested content (such as a web page or other suitable digital asset) for acceptance of a respective phone call over network 190 to the wireless base station 130-1; wireless base station 130-1 transmits the requested content or call response over wireless communication link 127-1 to antenna hardware 171 of the wireless station 121; via antenna hardware 126-1, the wireless station 121 wirelessly transmits the requested content or call response to the mobile communication device 161-1.

In a similar manner, the mobile communication device 161-2 communicates data (such as content request or other data) in upstream direction to the server resource 195; server resource 195 communicates data (such as requested content or other information) in a downstream direction to the mobile communication device 161-2.

In accordance with further example embodiments, note that the respective wireless stations or other suitable resources generate performance information associated with each of the subscriber domains and corresponding wireless stations and wireless communication links. The performance information enables the communication management resource 141 to determine which of the wireless access points are available for supporting supplemental connectivity with mobile communication devices in the network environment 100.

For example, wireless access point 121 can be configured to implement settings S1-1 (such as generated and distributed by the control management resource 141 or other suitable entity) to communicate over wireless communication link 127-1. In one embodiment, based on transmission and reception of wireless communications over wireless communication link 127-1, the wireless access point 121 or other suitable monitor resource (such as in wireless base station 130-1) generates performance information P1-1 indicating a performance or the respective wireless communication link 127-1. In one embodiment, the performance information P1-1 indicates information such as an amount of wireless bandwidth and/or latency associated with communications conveyed over the wireless communication link 127-1 to support wireless communications between the wireless base station 130-1 and the wireless access point 121. Note that, in one embodiment, the wireless base station 130-1 and corresponding service provider may be required to provide a certain service level of quality such as including bandwidth (such as above a bandwidth threshold level) and latency (such as below a latency threshold level) to the wireless access point 121 and corresponding mobile communication devices 161. Additionally, or alternatively, the performance information P1-1 can be configured to indicate whether the wireless connectivity service provided to the subscriber domain 150-1 and corresponding one or more mobile communication devices 161 is above or below respective service levels. Thus, the performance information is useful to determine if the wireless access point 121 or wireless base station 130-1 has any extra available wireless bandwidth to support communications with other mobile communication devices such as mobile communication device 166, mobile communication device 167, and so on. In other words, the performance information indicates that the 50% of available wireless bandwidth over the 127-1, then 50% of the available bandwidth associated with communication link 127-1 can be allocated for use by mobile communication device 166 or other suitable entity as further discussed herein.

Wireless station 122 can be configured to implement settings S2-1 (such as generated and distributed by the communication management resource 141 or other suitable entity) to communicate over wireless communication link 127-2. In one embodiment, based on transmission and reception of wireless communications over wireless communication link 127-2, the wireless access point 121 or other suitable monitor resource (such as in wireless base station 130-1) generates performance information P2-1 indicating a performance of the respective wireless communication link 127-2. In one embodiment, the performance information indicates information such as an amount of wireless bandwidth and/or latency associated with communications conveyed over the wireless communication link 127-2 to support wireless communications between the wireless base station 130-1 and the wireless station 122. Note that, in one embodiment, the wireless base station 130-1 and corresponding service provider may be required to provide a certain service level of bandwidth (such as above a bandwidth threshold level) and latency (such as below a latency threshold level) to the wireless access point 122 and corresponding mobile communication devices 162. Additionally, or alternatively, the performance information P2-1 can be configured to indicate whether the service provided to the subscriber domain 150-2 and corresponding one or more mobile communication devices 162 is above or below respective service levels. Thus, the performance information is useful to determine if the wireless station 122 or wireless base station 130-1 has any extra available wireless bandwidth to support communications with other mobile communication devices such as mobile communication device 166, mobile communication device 167, and so on. In other words, the performance information indicates that the 50% of available wireless bandwidth over the 127-1, then 50% of the available bandwidth associated with communication link 127-1 can be allocated for use by mobile communication device 166 or other suitable entity as further discussed herein.

Thus, the first wireless access point 121 and the wireless network 130 collectively establish a first wireless link 127-1 between the first wireless access point 121 and the wireless base station 130-1. The second wireless station 122 and the wireless network 130 collectively establish a second wireless link 127-2 between the second wireless station 122 and the wireless base station 130-2. The third wireless station 123 and the wireless network 130 collectively establish a third wireless link 127-3 between the third wireless station 123 and the wireless base station 130-2.

In further example embodiments, the wireless access points 121, 122, etc., (such as fixed wireless access stations or instances of customer premises equipment) and/or wireless base station 130 communicate the performance information P1-1, P2-1, P3-1, etc., to the control management resource 141 or other suitable entity in the network.

As further discussed herein, note again that wireless service level provided to each of the wireless access points 121, 122, 123, etc., can be continuously monitored to determine if it is possible to operate a respective wireless access point in a supplemental base station mode to support communications with one or more mobile communication devices 166, 167, etc., outside of or unaffiliated with the respective subscriber domain. For example, as further discussed herein, the wireless access point 121 can be configured to provide wireless connectivity to mobile communication device 166 if sufficient wireless resources over wireless communication link 127-1 are available to do so. If the wireless connectivity provided to the mobile communication device 166 causes the performance associated with supporting wireless communications to the wireless access point 121 to fall below a respective threshold level, or latency associated with transmitted data packs above a respective latency threshold, the control management resource 141 can be configured to discontinue operating the wireless access point 121 in supplemental base station mode.

As shown in FIG. 1, at time T1, in a manner as previously discussed, the wireless base station 130-1 provides each of the subscriber domains 150-1 and 150-2 connectivity to the remote network 190 via respective wireless communication link 127-1 and wireless communication link 127-2.

Additionally, the wireless base station 130-1 at least temporarily supports wireless connectivity 128-1 with the mobile communication device 166. The wireless connectivity 128-1 provides the mobile communication device 166 access to remote network 190 (such as the Internet, mobile phone network, etc.) and corresponding resources (such as server 195, mobile communication device 168, etc.) connected to it. The wireless base station 130-1 supports wireless connectivity 128-2 with the mobile communication device 167. The wireless connectivity 128-2 provides the mobile communication device 167 access to remote network 190 (such as the Internet, mobile phone network, etc.) and corresponding resources (such as server 195, mobile communication device 168, etc.) connected to it.

Note that the ability of the mobile communication device 166 to communicate with the wireless base station 130-1 may vary depending upon the location of the mobile communication device 166. For example, the wireless base station 130-1 may be disposed at a fixed location. At time T2, the mobile communication device 166 may have moved further away from the wireless base station 130-1 such that the wireless messages (i.e., signals) from the mobile communication device 166 no longer or weakly reach the wireless base station 130-1. As further discussed below, in such an instance, embodiments herein include operating the wireless access point 121 (such as customer premises equipment, wireless station, etc.) in a so-called relay mode in which the wireless access point 121 supports connectivity of the mobile communication device 166 to the wireless base station 131.

In still further example embodiments, the wireless base station 130-1 or other suitable entity monitors the location of any mobile communication devices that are at the edge of the respective network, indicating that they are susceptible to losing connectivity with the wireless base station 130-1. The wireless base station 130-1 or communication management resource 141 uses the received performance information as a basis to determine which if any of the instances of the wireless access point 121, 122, 123, etc., are available to support supplemental wireless connectivity of within-range mobile communication devices.

In one embodiment, if the wireless base station 131-1 (i.e., communication management resource) determines that a respective mobile communication device 166 is on the edge of the network and is potentially about to lose connectivity with the wireless base station 130-1, the wireless base station 130-1 communicates a respective command to the wireless access point 121.

In further example embodiments, communication management hardware such as associated with wireless access point 121 establishes wireless connectivity 127-1 with wireless base station 130-1 in a network environment 100. The wireless access point 121 provides one or more communication devices 161 in the subscriber domain 150-1 access to a remote network 190 over the first wireless connectivity 127-1 and through the wireless base station 130-1. As further discussed herein, in response to receiving notification (such as a command) to operate the wireless access point 121 in a supplemental wireless base station mode with respect to the wireless base station 130-1, the wireless access point 121 provides the mobile communication device 166 located outside of the subscriber domain 150-1 and/or unaffiliated with the subscriber domain 150-1 access to the remote network 190 through the wireless access point 121.

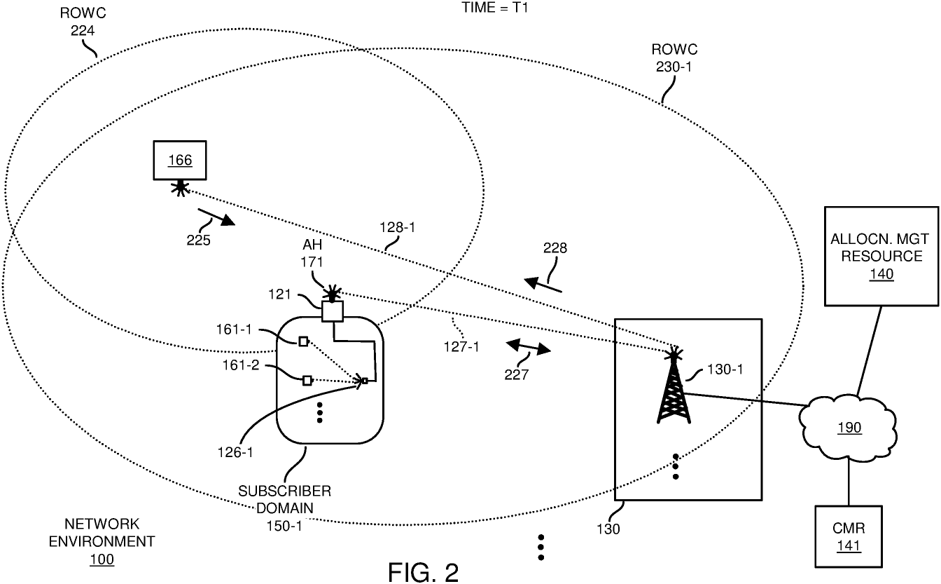

FIG. 2 is an example diagram illustrating the inability or difficulty of a mobile communication device to communicate with a respective wireless base station and monitoring by customer premises equipment according to embodiments herein.

In this example embodiment, the mobile communication device 166 is initially in communication with the wireless base station 130-1 over wireless communication link 128-1. Assume that the mobile communication device 166 is sufficiently far away from the wireless base station 130-1 such that it only has poor wireless connectivity in the uplink direction to the wireless base station 130-1.

Any of one or more resources in the wireless network environment 100 can be configured to detect the poor wireless connectivity between the mobile communication device 166 and wireless base station 130-1. For example, the mobile communication device 166 can be configured to detect conditions in which the mobile communication device 166 communicates with the wireless base station 130-1, but the wireless base station 130-1 does not respond with response wireless communications such as because the wireless base station 130-1 does not receive the communication s from the mobile communication device 166. Additionally, or alternatively, the wireless access point 121 can be configured to monitor one or more wireless communications between the mobile communication device 166 and the wireless base station 130-1. The wireless access point 121 can determine conditions in which the mobile communication device transmits communications to the wireless base station 130-1, but the wireless base station 130-1 does not respond. Still further, the wireless base station 131 can be configured to monitor conditions in which the mobile communication device 166 does not respond to the downlink communications transmitted from the wireless base station 130-1.

Yet another way that the wireless base station 130-1 can determine a condition in which the wireless connectivity 128-1 provides poor wireless service between the mobile communication device 166 and the wireless base station 130-1 is via the wireless base station 130-1 monitoring a wireless power level at which communications 225 are received from the mobile communication device 166 at the wireless base station 130-1. If the magnitude of the wireless power level at which communications 225 are received at the wireless base station 130-1 is below a power threshold level, the wireless base station 131 considers handing off the mobile communication device 166 to another wireless base station such as wireless base station 130-2 if it happens to be in the vicinity of the mobile communication device 166. Assume that there are no other wireless base stations 130 available to provide the mobile communication device 166 wireless connectivity, the communication management resource 141 can be configured to identify one or more instances of fixed wireless access points such as wireless access point 121 in a vicinity of the mobile communication device 166. The instances of wireless access point are possible candidates in which to provide the mobile communication device 166 connectivity to the remote network as an alternative to wireless communication link 128-1.

More specifically, assume that the communication management resource 141 knows the location of the mobile communication device 166 as well as the location of the wireless access point 121 operated in the subscriber domain 150-1. Given that the respective mobile communication device 166 has a limited range of wireless coverage 224 in the uplink direction to the wireless base station 130-1, the communication management resource 141 determines the availability of one or more instances of customer premises equipment in a vicinity of the communication device 166. In this example embodiment, the communication management resource 141 determines that the mobile communication device 166 resides in a vicinity of the wireless access point 121 and corresponding subscriber domain 150-1. As previously discussed, the wireless access point is originally dedicated to operating in the subscriber domain 150-1 and providing communication devices 161 wireless connectivity at a sufficiently high level of quality over the wireless communication link 127-1 to the wireless base station 130-1 and corresponding remote network 190.

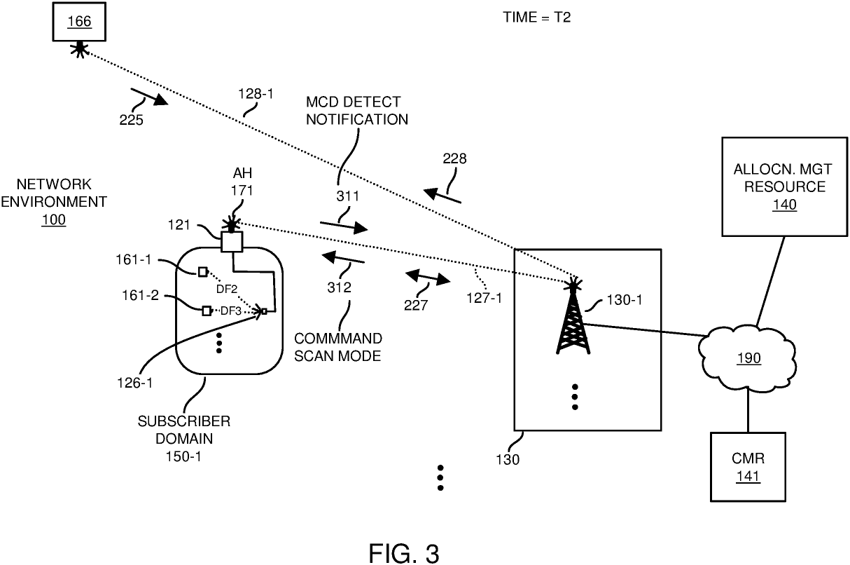

FIG. 3 is an example diagram illustrating detection of a mobile communication device losing or experiencing poor wireless connectivity and respective notification by a communication management resource to operate the wireless access point in a wireless channel scan mode according to embodiments herein.

As previously discussed, any suitable resource in the network environment 100 can be configured to provide notification to the wireless base station 130-1 and communication management resource 141 of nearby communication devices and the ability of the nearby communication devices unaffiliated with the subscriber domain 150-1 to transmit and receive wireless communications from the wireless base station 130-1.

In one embodiment, the wireless access point 121 detects presence of the mobile communication device 166 as being nearby the wireless access point 121. In such an instance, the wireless access point 121 transmits wireless communications 311 indicating presence of the mobile communication device 166 to the communication management resource 141. In one embodiment, the wireless access point 121 monitors a power level of receiving wireless communications 225 from the mobile communication device 166. Depending on a respective magnitude of the power level of the wireless access point 121 receiving the wireless communications 225, the wireless access point 121 or other suitable entity such as communication management resource 141 can determine a nearness of the mobile communication device 166 with respect to the wireless access point 121.

Assume that the communication management resource 141 determines or detects that the mobile communication device 166 is only provided poor wireless connectivity with the wireless base station 130-1 via the wireless communication link 127-1. As previously discussed, the poor wireless service connectivity can be determined in any of multiple different ways.

In this example embodiment, the communication management resource 141 receives notification of the poor wireless service from one or more resources in the network environment 100. In response to detecting that the wireless communication link 120-1 between the mobile communication device 166 and the wireless base station 130-1 provides a wireless service below a respective wireless service threshold level, the communication management resource 141 transmits communications 312 through wireless base station 130-1 over the wireless communication link 127-1 to the wireless access point 121.

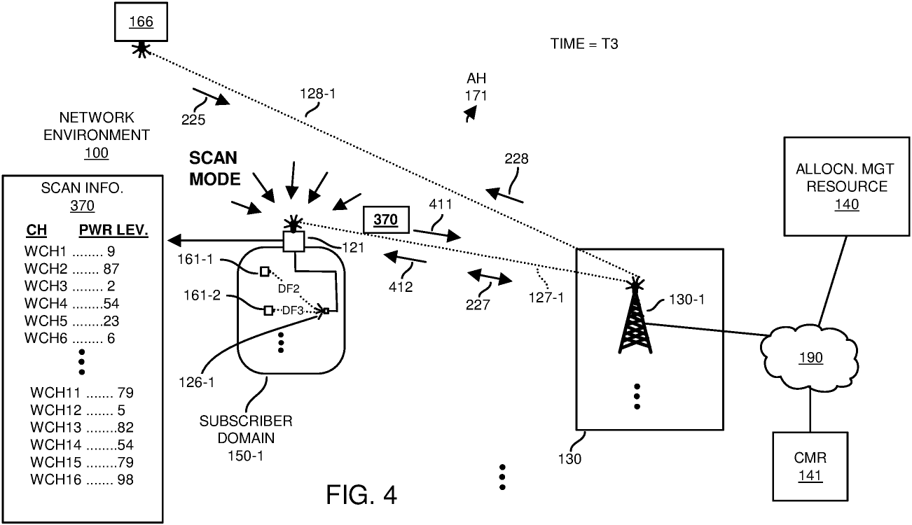

In one embodiment, the communications 312 include a command from the communication management resource 141. The command notifies the wireless access point 121 to operate in a scan mode in which the wireless access point 121 monitors usage of multiple wireless channels in a corresponding wireless band. In one embodiment, the wireless band monitored by the wireless access point 121 is a so-called CBRS (Citizens Band Radio System) band comprising PAL wireless channels and GAA wireless channels. Additional details of scanning and reporting discussed in FIG. 4 below.

FIG. 4 is an example diagram illustrating operation of customer premises equipment in a scan mode to generate respective wireless channel scan information and communication of the wireless channel scan information to a remote management resource according to embodiments herein.

In response to receiving notification from the communication management resource 141 to operate in a scan mode via communications 312, the wireless access point 121 monitors a wireless power level of receiving the communications over each of multiple wireless channels in a particular band. In this example embodiment, assume that the band monitored by the wireless access point includes 15 wireless channels: WCH1, WCH2, WCH3, WCH4, ..., WCH10, WCH11, WCH12, WCH13, WCH14, and WCH15.

Based on monitoring the usage of respective wireless channels while in the scan mode, the wireless access point 121 produces the scan information 370. Assume in this example embodiment that a low power level number (such as near 0) in the scan information indicates low detected wireless power in the respective wireless channel and thus usage of the respective wireless channel while a higher #such as near 100 indicates a respective high detected wireless power and high usage of that wireless channel by one or more other wireless stations in the vicinity of the wireless access point 121.

In such an instance, because of low wireless interference, the wireless channel WCH12 is a good candidate to provide wireless connectivity between the wireless access point 121 and the mobile communication device 166. In other words, the wireless channel WCH12 is relatively unused while the other wireless channels WCH11, WCH13, WCH14, WCH15 appear from the perspective of the wireless access point 121 to be heavily used by other wireless stations. Because the wireless channel WCH12 is unused, it most likely provides best wireless service between the mobile communication device 166 and the wireless access point 121 to support respective wireless communications over a new wireless communication link.

As further shown, via communications 411, the wireless access point 121 communicates the respective scan information 370 to the communication management resource 141 or other suitable entity. As further discussed herein, the communication management resource 141 selects one or more of the available wireless channels for use by the wireless access point to communicate with the mobile communication device 166. In this example embodiment, assume that the communication management resource 141 selects wireless channel WCH12 and notifies the wireless access point 121 to use wireless channel WCH12 to provide wireless connectivity between the mobile communication device 166 and a wireless access point 121 during a respective mode of operating the wireless access point 121 and a supplemental wireless base station mode.

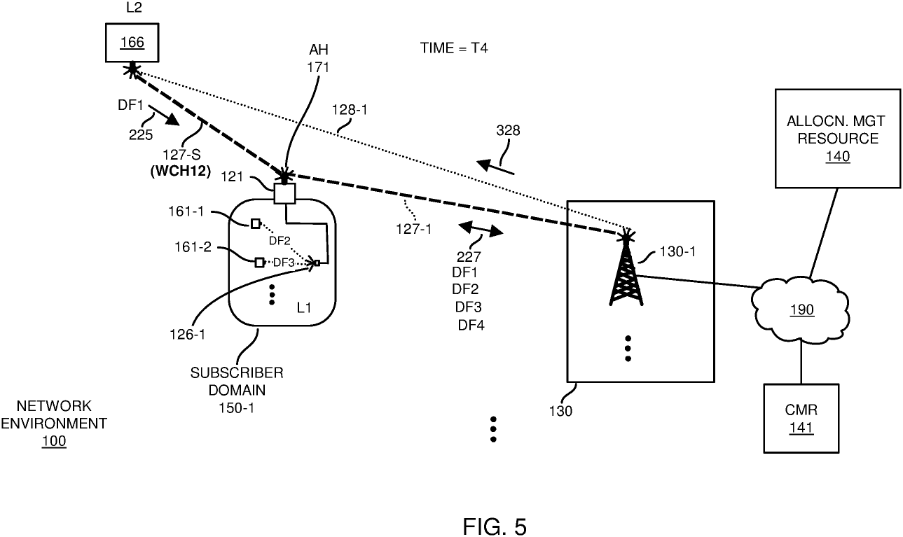

FIG. 5 is an example diagram illustrating operation of respective customer premises equipment in a supplemental base station mode providing wireless connectivity to a mobile communication device according to embodiments herein.

As previously discussed, the wireless access point 121 can be configured to operate in a respective supplemental base station mode based on a respective one or more communications such as commands received from the communication management resource 141 or other suitable entity. For example, in one embodiment, the wireless access point 121 initially provides wireless service (such as private wireless service connectivity) and corresponding connectivity of the communication devices 161 in the subscriber domain 150-1 to the remote network 190 via conveyance of wireless communications 227 over the wireless communication link 127-1 to and through wireless base station 130-1 to the remote network 190.

In one embodiment, in response to receiving a command to operate in the supplemental base station mode, the wireless access point 121 establishes a first wireless communication link 127-S between the wireless access point 121 and the mobile communication device 166. The wireless access point 121 also establishes or uses bandwidth of an existing second wireless communication link 127-1 between the wireless access point 121 and the wireless base station 130-1 to support wireless connectivity (via transmission of data packets) from the mobile communication device 166 and/or data packets associated with the mobile communication devices 161-1, 161-2, etc.

As further shown in this example embodiment, when operating in the supplemental wireless base station mode, the wireless access point 121 receives first communications in dataflow DF1 from the mobile communication device 166 over the first wireless communication link 127-S and then transmits the first communications associated with dataflow DF1 from the wireless access point 121 over the wireless communication link 127-1 to the wireless base station 130-1.

In one embodiment, prior to communicating the data flow DF1 to the wireless base station 130-1, the wireless access point 121 tags the communications associated with data flow DF1 with a respective unique identifier value tag to indicate that they (or corresponding data) are received from the mobile communication device 166. If desired, in one embodiment, the wireless access point 121 can be configured to receive second communications (directed to the mobile communication device 166) from the wireless base station 130-1 over the wireless communication link 127-1. In such an instance, the wireless access point 121 operating in the supplemental base station mode transmits the received second communications from the wireless base station 130-1 over the wireless communication link 127-S to the mobile communication device. Thus, the wireless access point 121 can be configured to operate in a supplemental wireless base station mode.

Additionally or alternatively as shown in FIG. 5, note that the wireless base station 130-1 can be configured to transmit at a sufficiently high wireless power level to communicate directly with the mobile communication device 166 over the wireless communication link 128-1. In such an instance, the wireless base station 130-1 may not communicate any downlink communications over wireless communication link 127-1 to the wireless access point 121 as the wireless base station 130-1 communicates the downlink data directly to the mobile communication device 166.

Note further that the mobile communication device 166 may rely on use of control plane connectivity and data plane connectivity with the wireless base station 130-1 in order to communicate through the wireless access point 121 or directly with the wireless base station 130-1.

In further example embodiments, note that the wireless communication link 128-1 can be configured to support control plane communications (such as the wireless base station 130-1 notifying the mobile communication device 166 of a wireless transmit direction, channels, power levels, etc., at which to communicate wireless signals to the wireless access point 121) and/or downlink communications from the wireless base station 130-1 to the mobile communication device 166. In a manner as previously discussed, the supplemental wireless communication link 127-S and relay operation (or supplemental base station mode operation) of the wireless access point 121 supports uplink communications (such as data associated with the data plane) from the mobile communication device 166 to the wireless base station 130-1.

Thus, embodiments herein include wireless base station 130-1 initially supporting a communication session between the wireless base station 130-1 and the mobile communication device 166 independent of wireless communication link 127-1; the communication session with the mobile communication device 166 includes a control plane supporting conveyance of control information and data planes supporting conveyance of data packets. The communication session initially includes a first data plane supporting conveyance of data payload information; the control information associated with the control plane controls conveyance of the data payload information over the data plane. The wireless access point 121 can be configured to receive a handoff of the first data plane from the wireless base station 130-1 to the wireless access point 121.

Note further that the wireless system as described herein can be configured to support time division duplex communications. For example, one or more wireless channels can be split into first time slots supporting downlink communications and second time slot supporting uplink communications. The wireless stations are assigned use of those different time slots to support conveyance of respective information and/or data. In one embodiment, the wireless communication link 127-S supports first time-division duplex communications; the wireless communication link 127-1 second time-division duplex communications. Via appropriate scheduling management at the wireless access point 121, the second time division duplex communications are synchronized with the first time-division duplex communications. In one embodiment, the timeslot in which communications received from the mobile communication device 166 align with timeslots of the wireless access point 121 communicating those communications over wireless communication link 127-1.

As always, please let us know if you have any questions or if we can be of assistance.

Thus, in one embodiment, the wireless access point 121 can be configured to schedule communications between the mobile communication device 166 and the wireless base station 130-1 to continue an otherwise dropped wireless connection between the mobile communication device 166 and the wireless base station 130-1. Thus, even though the mobile communication device 166 is unable to directly communicate with the wireless base station 130-1 because it’s wireless transmit power level is too low (such as to save power), the mobile communication device 166 is able to communicate through the wireless access point 121 to the wireless base station 130-1 over the shared data flows supported by the wireless communication link 127-1. As previously discussed, in a reverse direction, if needed, the wireless base station 130-1 is able to communicate respective downlink data flows through the wireless access point 121 to the mobile communication device 166. Alternatively, the wireless access point 121 receives downlink communications from the wireless base station 130-1 and communicates them over the wireless communication link 127-S to the mobile communication device 166 via data flow DF1 or other data flow.

Thus, the wireless access point 121 (such as customer premises equipment or first wireless access point) provides, via a private wireless service paid by a respective subscriber associated with the subscriber domain 150-1, mobile communication devices 161-1, 161-2, etc., (user equipment) in subscriber domain 150-1 access to a remote network 190 over first wireless connectivity (wireless communication link 127-1) between the wireless access point 127-1 and the wireless base station 130-1. Via communication links 127-S and 127-1, as long as the mobile communication devices 161 receive a private wireless service above a threshold level, the wireless access point 121 provides the mobile communication device 166 access to the remote network 190 through the wireless access point 121 even though the mobile communication device 166 is disposed outside the subscriber domain 150-1 and is unaffiliated with the wireless access point 121 and subscriber domain 150-1.

In additional embodiments, as further discussed herein, the wireless access point 121 communicates over communication link 127-1 and through wireless base station 130-1 to receive allocation of wireless channels from the allocation management resource 140. Further example embodiments herein include, via the wireless access point 121, receiving allocation of one or more wireless channels from the allocation management resource 140 or other suitable entity. The allocated wireless channels support connectivity (such as wireless communication link 127-S) between the wireless access point 121 and the mobile communication device 166.

Subsequent to receiving approval (allocation) to use respective one or more wireless channels to support communications in the network environment 100, in one embodiment, the wireless access point 121 receives and/or transmits heartbeat messages associated with use of the allocated wireless channels from the wireless access point 121 to the allocation management resource 140 (such as a spectrum access system) to receive continued rights (via grants) to use the allocated wireless channels. Without the continued grants from the allocation management resource 140, the wireless access point 121 must discontinue use of the allocated wireless channels.

In one embodiment, the allocated wireless channels are channels allocated from a CBRS (Citizens Band Radio System) spectrum, although the wireless channels can be allocated from any suitable band

Note further that embodiments herein include, in response to the wireless access point 121 detecting the failure of the wireless base station 130-1 to respond to a request communication, transmitting a message from the wireless access point 121 to the wireless base station 130-1 (the message indicates an identity of the mobile communication device 166) and receiving allocation of one or more wireless channels to support connectivity between the wireless access point 121 and the mobile communication device 166.

Thus, embodiments herein include communication management hardware (such as communication management resource 141) such as associated with customer premises equipment. The wireless access point 121 establishes first wireless connectivity 127-1 with a first wireless base station 130-1 in a network environment. The wireless access point 121 provides one or more communication devices 161 in the subscriber domain 150-1 access to a remote network 190 over the first wireless connectivity 127-1 and through the first wireless base station 130-1. In response to receiving notification (such as a command via communications 412) to operate the customer premises equipment in a supplemental wireless base station mode (such as a public mode of providing wireless service to one or more mobile communication devices unaffiliated with the subscriber domain 150-1) with respect to the first wireless base station 130-1, the wireless access point 121 provides the mobile communication device 166 located outside of the subscriber domain 150-1 access to the remote network 190 through the wireless access point 121 (customer premises equipment).

In further example embodiments, the wireless access point 121 or other suitable entity (such as wireless base station 130-1, communication management resource 141, etc.) monitors a collective bandwidth service or services (such as data flow DF2, DF2, etc.) provided by the first wireless communication link 127-1 to the one or more communication devices 161 in the subscriber domain 150-1. The wireless access point 121 and/or wireless base station 130-1 share a portion of the wireless bandwidth associated with the wireless communication link 127-1 to support the second wireless connectivity (data flow DF1). However, in one embodiment, the wireless access point 121 does not provide public wireless connectivity to the mobile communication device 166 at the expense of the private services provided to the communication devices in subscriber domain 150-1.

For example, wireless access point 121 (i.e., communication management resource) prevents the collective bandwidth service associated with data flow DF2, DF3, etc., from falling below a threshold level because the subscriber associated with subscriber domain 150-1 pays a respective fee to use the private wireless services provided by the wireless communication link 127-1. For example, in one embodiment, the wireless access point 121 (customer premises equipment) limits an amount of wireless bandwidth associated with data flow DF1 in wireless communication link 127-1 supporting communications between the mobile communication device 166 and the remote network 190.

As previously discussed, in one embodiment, the wireless access point 121 or other suitable entity or equipment scans use of wireless channels at a location L1 where the wireless access point 121 resides. Based on the scanning, the wireless access point 121 and communication management resource 141 determine a degree of usage associated with wireless channels available in a wireless spectrum. The wireless access point 121 communicates the scanning information 370 associated with the monitored wireless channels at location L1 to the communication management resource 141 and/or allocation management resource 140. The wireless access point 121 receives selection of a wireless channel (such as an interference free GAA wireless channel such as wireless channel #12) amongst the wireless channels from the allocation management resource 140 and/or communication management resource 141.

Via the selected wireless channel #12 (wireless channel WCH12), the wireless access point 121 establishes the second wireless communication link 127-S (supplemental wireless connectivity) between the wireless access point 121 and mobile communication device 166 at location L2 to provide the mobile communication device 166 access to the remote network 190 over the wireless communication link 127-S.

As further discussed herein, the wireless access point 121 can be configured to establish a heartbeat channel between the wireless access point 121 and the allocation management resource 140 (such as spectrum access system) controlling use of the selected wireless channel WCH12. The wireless access point 121 provides continued use of the selected wireless channel WCH12 to support the second wireless connectivity 127-S with the mobile communication device 166 in response to repeatedly receiving grant notifications from the allocation management resource 140 or other suitable entity allowing continued use of the second wireless connectivity 127-S (wireless channel WCH12) by the wireless access point 121. In one embodiment, the wireless access point 121 receives the grant notifications from the allocation management resource 140 over the first wireless communication link 127-1 through the wireless base station 130-1.

Still further example embodiments herein include, at the wireless access point 121, receiving communication control information (such as via communication 412 as previously discussed with respect to FIG. 4) over the first wireless communication link 127-1 from the wireless base station 130-1. The communication control information notifies the wireless access point 121 to operate in the supplemental wireless base station mode via establishing second wireless communication link 127-S between the wireless access point 121 and the mobile communication device 166. In one embodiment, the communication control information specifies one or more parameters such as an identity of the mobile communication device 166 in which to provide connectivity to the remote network 190 via the second wireless communication link 127-S and the first wireless communication link 127-1.

In yet further example embodiments, the wireless access point 121 is a fixed wireless access point providing the one or more communication devices 161 in the subscriber domain 150-1 and the mobile communication device 166 outside the subscriber domain 150-1 access to the remote network 190 over the first wireless communication link.

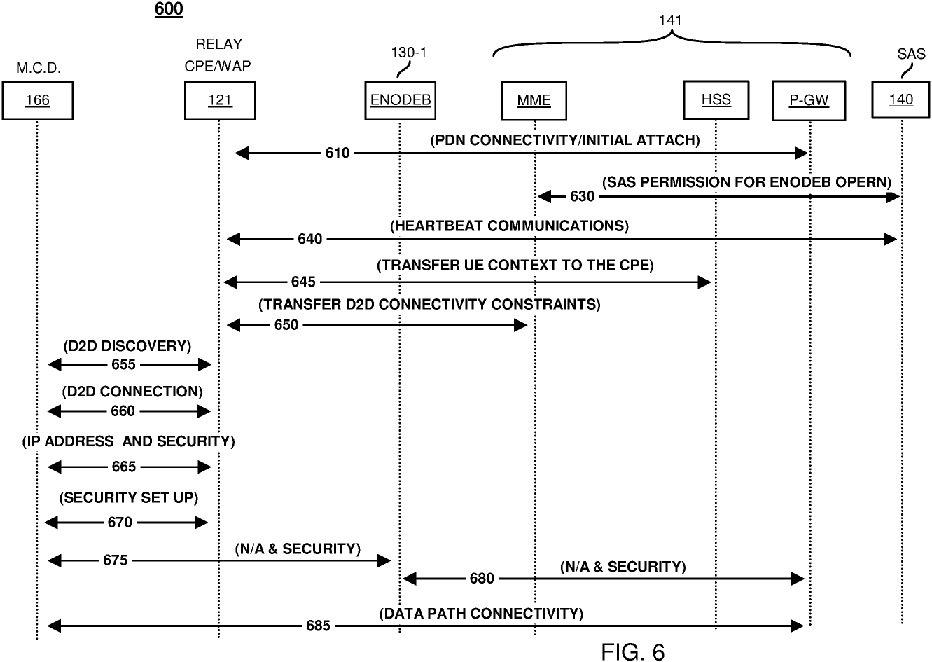

FIG. 6 is an example diagram illustrating communication flow amongst multiple entities in a wireless network to support connectivity through a customer premises equipment operating in a supplemental base station mode according to embodiments herein.

### No Channel Scanning by the CPE Relay Node

As previously discussed, fixed wireless access (FWA) is conventionally used to provide broadband internet services in rural as well as urban areas. In general, customer premises equipment (CPE) is disposed at a fixed location and provides connectivity to the service provider’s infrastructure such as a main wireless base station. The CPE (wireless access point 121) is high powered and provides higher antenna gain i.e., 10 - 15 dBi. In comparison to UEs, which are usually 0 - 2 dBi.

Embodiments herein include an implementation of respective customer premises equipment that provide additional wireless coverage to mobile communication devices disposed outside of a respective subscriber domain. This improves the Link budget of the UEs that are within wireless range of the customer premises equipment.

Note that, in one nonlimiting example embodiment, CBRS band provides 150 MHz of bandwidth of which 50 MHz is typically GAA (such as 5 wireless channels). In general, anyone can transmit/receive in those GAA channels within the defined confinements mandated by FCC.

In certain instances, a so-called macro transmitter for the main wireless base station 130-1 is usually high powered and able to send the signal farther than the UEs. UEs may have a short range and therefore unable to communicate with the wireless base station 130-1 over wireless communication link 128-1.

In one embodiment, the wireless access point 121 operates in a supplemental base station mode or a relay mode to improve uplink quality for the mobile communication device 166 such as by 7 - 15 dBi.

Further, as previously discussed, the wireless access point 121 can be configured to operate as a supplemental base station with respect to the main wireless base station 130-1. In such an instance, the wireless access point 121 (customer premises equipment) acts as a relay and supports communications from the UE (i.e., mobile communication device or user equipment) in the uplink direction from the mobile communication device 166 through the wireless access point 121 to the main wireless base station 130-1. When operated in a respective CBRS band, the wireless access point 130-1 is not able to use respective wireless channels without permission from a respective allocation management resource 140 (spectrum access system).

In one embodiment, the allocation management resource 140 (such as spectrum allocation system or SAS) is notified of various parameters associated with operating the wireless access point 121 as a relay agent supporting wireless connectivity to one or more mobile communication devices disposed outside of a respective subscriber domain 150-1 to which the wireless access point 121 is assigned or resides.

Embodiments herein include a system, process, method, etc., in which the one or more instances of customer premises equipment are used as relays operating in a supplemental wireless base station mode. In one embodiment, the customer premises equipment operating in the relay mode appears as a UE itself to the donor enodeB (main wireless base station), while the customer premises equipment acts as an enodeB to the UE disposed outside the subscriber domain or within the subscriber domain.

In one embodiment, the wireless access point 121 such as communication management resource associated with the network 130 first determines the performance of the network and corresponding communication links. If the UEs (a.k.a., communication devices, mobile communication devices, etc.) are too far from the donor enodeB (main wireless base station 130-1), the overall performance of the wireless service to the mobile communication device 166 decreases. For example, the enodeB will have to provide more resources through its scheduler to these UEs which will be burdensome and reduce the performance.

In further example embodiments, the wireless base station 130-1 (and communication management resource 141) determines when to switch the wireless access point 121 to the supplemental wireless base station mode. In one embodiment, a communication management module such as “smart CPE relay” assists the network in determining these conditions. The smart CPE relay module at the wireless access point 121 or other suitable entity helps the network 130 and main wireless base station 130-1 to determine when to activate a respective instance of customer premises equipment in the supplemental wireless base station mode. In one embodiment, the module in the customer premises equipment (or other suitable entity) determines presence of any low performing UEs (based on Low MCQs or other parameter) connected to the main wireless base station 130-1, locates and assesses how much of a load the UEs outside the subscriber domain 150-1 are putting a burden on the main wireless base station 130-1 (i.e., top 25% low performing UEs that utilize 50% of the resources for example).

After finding these UEs (such as including mobile vacation device 166), the smart CPE relay looks for candidate instances of CPE’s nearby and determines if switching wireless connectivity to any of those CPEs will improve the situation, i.e., UEs will improve the MCQ performance.

After the smart CPE relay has determined the available candidate CPEs (such as including wireless access point 121), it or another suitable entity instructs a specific one or more candidate CPEs to run an iPerf client on it to determine if they can provide more throughput for the mobile communication device 166 meeting wireless assistance.

As further discussed herein, the selected CPE operating in the relay mode can be configured to use any suitable protocol such as wireless communication protocol D2D to communicate with the communication devices. After finding and selecting a desired customer premises equipment to operate in the supplemental wireless base station mode and provide connectivity to the stranded communication devices (such as mobile communication device 166), the main wireless base station or other suitable entity runs background checks and establishes virtual pipelines (data flows) to keep the traffics associated with its own communication devices in subscriber domain separate from data flows associated with communications from the one or more mobile communication devices outside the subscriber domain. This is done for various purposes such to keep the traffic separate and provide quality of service. i.e., not to degrade CPE’s performance.

Before implementing operation of the wireless access point 121 in a supplemental wireless base station mode, the main wireless base station 130-1 registers the selected CPE (wireless access point 121) with the spectrum access system (allocation management resource 140). In one embodiment, this is only performed by the main wireless base station 130-1 because the main wireless base station (a.k.a., network 130) already has all the credentials about the selected wireless access point 121. However, in one embodiment, the credentials are modified by the main wireless base station in order to operate the selected customer premises equipment in the relay mode. For example, some of the SAS parameters are CbsdSerialNumber; Latitude; Longitude; Height; HeightType; IndoorDeployment; AntennaAzimuth; AntennaDowntilt; AntennaGain; AntennaBeamwidth.

Subsequent to registering with the allocation management resource 140, the EPC provides information such as security settings, limits on the number of users, and allocated bandwidth for the communication devices (such as including mobile communication device 166) through the wireless access point 121.

In further example embodiments, the wireless access point 121 operates or appears as a UE type of equipment with respect to the main wireless base station 130-1 as well as to the mobile communication devices to be supported by the customer premises equipment operating in the supplemental wireless base station mode. The operation is time synchronized is under the control of the EPC for transmission and scheduling purposes.

In one embodiment, the wireless access point 121 implements D2D or other suitable wireless communication protocol to communicate with the UEs. Additional operation details are discussed below via communication flow 600.

In response to the wireless access point 121 receiving a command from the communication management resource 141 or other suitable entity to operate in the supplemental wireless base station mode supporting public connectivity, via communications 610, the wireless access point 121 establishes connectivity through wireless base station 130-1 with a gateway (a.k.a., P-GW) of the communication management resource 141. The gateway P-GW provides the wireless access point 121 connectivity to a respective network 190 such as the Internet, cellular network, etc.

Via communications 630, the MME communicates with the allocation management resource 140 (such as spectrum access system) to provide appropriate parameters/settings for the wireless access point 121 to use one or more wireless channels. In one embodiment, as previously discussed, the allocation management resource 140 allocates the use of wireless channel WCH12 to the wireless access point 121 to communicate with the mobile communication device 166.

Via communications 640, before and after establishing the wireless connectivity 127-S between the wireless access point 121 and the mobile communication device 166, the wireless access point 121 repeatedly communicates heartbeat requests to the allocation management resource 140. The allocation management resource 140 (such as spectrum access system) repeatedly responds with grant communications to the wireless access point 121, the responses indicating that the wireless access point 121 is able to continue use of the previously allocated wireless channels.

Via communications 645, the wireless access point 121 communicates information about the mobile communication device 166 to the HSS. The HSS associated with the communication management resource 141 transfers the context of the mobile communication device 166 to the wireless access point 121.

Via communications 650, the MME notifies the wireless access point 121 that it is able to operate in the supplemental wireless base station mode to support connectivity with one or more mobile communication devices that are unable to communicate with or that are out of range with respect to the wireless base station 130-1. In one embodiment the transmitted communication settings (such as including D2D connectivity constraints) include information (such as wireless power transmit levels, wireless signal directivity, power step up control, number of allowable wireless connects to respective communication devices, etc.) controlling operation of the wireless access point 121 to communicate in the wireless network environment 100.

In one embodiment, the communication management resource determines to handoff the mobile communication device 166 to the wireless access point 121. In such an instance, the wireless base station 130-1 transmits a downlink communication to the mobile communication device to execute a D2D mode to establish wireless connectivity with the wireless access point 121. As previously discussed, the wireless access point 121 is notified to operate in a supplemental wireless base station mode to support connectivity with the wireless base station 130-1.

In one embodiment, the communication management resource 140 notifies the wireless access point 121 of a first unique identifier value assigned to the mobile communication device 166. The communication management resource 140 notifies the mobile communication device of a second unique identifier value assigned to the wireless access point 121. As further discussed below, device discovery and respective connectivity can include the wireless access point 121 communicating its unique identifier value to the mobile communication device 166. In such an instance, the mobile communication device matches the identity information received from the communication management resource 141 to the unique identifier value received from the wireless access point 121 to determine that the mobile communication device 166 is to establish connectivity with the wireless access point 121. Additionally, or alternatively, the wireless access point 121 matches the identity information received from the mobile communication device 166 during discovery to the unique identifier value received from the communication management resource 141 to determine that the wireless access point 121 is to establish connectivity with the mobile communication device 166.

Subsequent to receiving the communication settings information from the MME, the wireless access point 121 establishes wireless connectivity 127-S between the wireless access point 121 and the mobile communication device 166. For example, via communications 655, the wireless access point 121 discovers presence of mobile communication device 166 such as via D2D or other suitable wireless communication protocol.

Via communications 660, the wireless access point 121 establishes a wireless connection (using wireless channel WCH12) with the mobile communication device 166 such as via D2D or other suitable wireless communication protocol.

Via communications 665 and 670 between the mobile communication device 166 and the wireless access point 130-1 and/or MME, the mobile communication device 166 receives a respective assigned network address and security information in order to set up a corresponding data path between the mobile communication device 166 and the Gateway. For example, via communications 665, the mobile communication device 166 receives an IP network address to support connectivity with the wireless access point 121. Via communications 670, the mobile communication device 166 receives any encryption information to support secured communications with the wireless access point 121.

Via communications 675, the wireless access point 121 supports data flow setup between the mobile communication device 166 through the wireless access point 121 to the wireless base station 130-1.

Via communications 680, the wireless base station 130-1 provides notification of network address information and security information such as encryption information to the gateway.

Via communication 685, the mobile communication device 166 communicates uplink data through the wireless access point 121 and wireless base station 130-1 to the Gateway P-GW. In one embodiment, the Gateway forwards the uplink communications to the appropriate destination in the remote network 190. In a reverse direction, the Gateway receives communications from one or more entities in the network 190 and forwards them in the downlink direction through the wireless base station 130-1 and the wireless access point 121 to the mobile communication device 166.

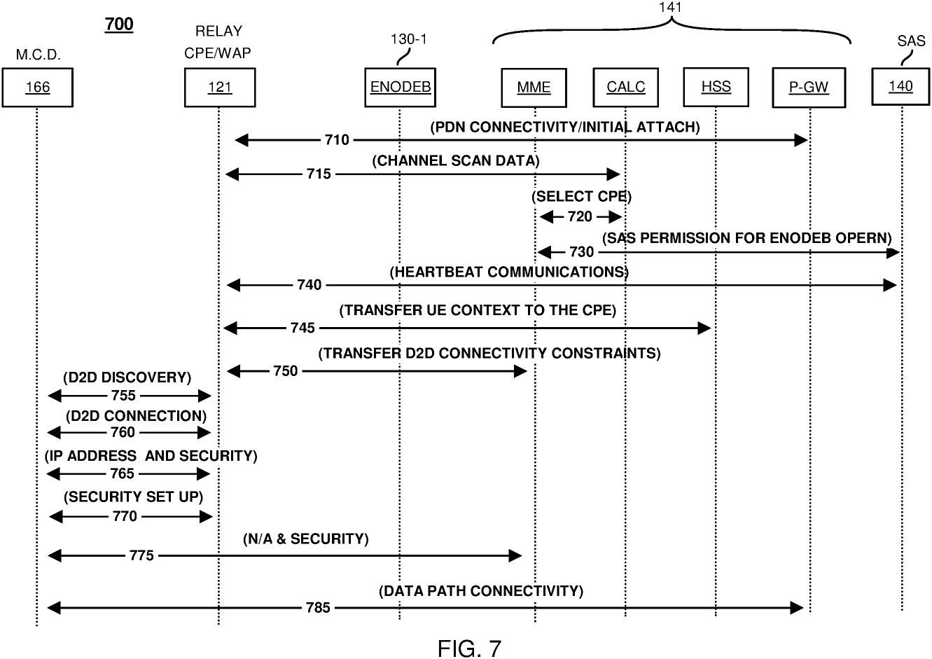

FIG. 7 is an example diagram illustrating communication flow amongst multiple entities in a wireless network to support connectivity through a customer premises equipment operating in a supplemental base station mode according to embodiments herein.

### Channel Scanning (Such as GAA Channels) by the CPE Relay Node

Fixed wireless access (FWA) is conventionally used to provide broadband internet services in rural as well as urban areas. In general, fixed wireless access customer premises equipment (CPE) is fixed (i.e., the wireless access point does not move or is stationary) and provides connectivity to the service provider’s infrastructure such as a main wireless base station. The CPE is usually high powered and provides higher antenna gain i.e., 10 - 15 dBi. In comparison to UEs. UE’s are usually 0 - 2 dBi.

To address issues associated with the prior art, embodiments herein include an implementation of respective customer premises equipment that provide additional wireless coverage to mobile communication devices disposed outside of a respective subscriber domain. This improves the Link budget of the UEs that are within wireless range of the customer premises equipment.

Note that CBR provides 150 MHz of bandwidth of which 50 MHz is GAA. In general, anyone can transmit/receive in those GAA channels within the defined confinements mandated by FCC.

In certain instances, a so-called macro transmitter for main wireless base station 130-1 – is usually high powered and able to send the signal farther than the UEs. UEs may have a short range and therefore unable to communicate with the wireless base station 130-1 in network 130.

As previously discussed, the wireless access point 121 can be configured to operate as a supplemental wireless base station with respect to the main wireless base station 130-1. In such an instance, the customer premises equipment acts as a relay and supports communications from the UE (i.e., mobile communication device or user equipment) in the uplink direction from the mobile communication device through the customer premises equipment to the main wireless base station. When operated in a respective CBRS band, the wireless access point 121 is not able to use respective wireless channels without permissions from a respective spectrum access system (i.e., allocation management resource).

In one embodiment, the spectrum allocation system (SAS) or allocation management resource 140 is notified of various parameters associated with operating the customer premises equipment as a relay agent supporting wireless connectivity to one or more mobile communication devices disposed outside of a respective subscriber domain to which the customer premises equipment is assigned or resides. Embodiments herein include a system, process, method, etc., In which the one or more instances of wireless access point 121 or other customer premises equipment are used as relays. In one embodiment, the customer premises equipment operating the relay mode appears as a UE itself to the donor enodeB (main wireless base station) while the customer premises equipment acts as an enodeB to the UE disposed outside the subscriber domain or within the subscriber domain.

In normal operation, the main wireless base station (such as including an enodeB) and UE transmit in contiguous or non-contiguous bands (wireless channels) of CBRS. The wireless channels may be PAL and/or GAA channels to provide services.

Mere use of wireless channels without knowledge of interference associated with those channels is not the best way to utilize GAA by an operator, as there are other operators within the vicinity of the macro-cell. This disclosure includes the observation that use of GAA wireless channels support wireless connectivity via the customer premises equipment operating in the relay mode may be detrimental during conditions in which use of the GAA channels is will be detrimental over time as the GAA space would get crowded.

As previously discussed, embodiments herein include implementing customer premises equipment as a relay, however, the CPE as described herein can be configured to will find a clean GAA channel with the help from EPC and/or SAS.

In one embodiment, the customer premises equipment such as communication management resource associated with the network first determines the performance of the network. If the UEs to be supported by the customer premises equipment operating in the relay mode are too far from the donor enodeB (main wireless base station), the overall performance of the network will decrease. For example, the enodeB will have to provide more resources through its scheduler to these UEs which will be burdensome and reduce the performance.

The wireless base station determines when to switch the CPE to the supplemental wireless base station mode. In one embodiment, a communication management module such as “smart CPE relay” assists the network in determining these conditions. The smart CPE relay module at the customer premises equipment helps the network and main wireless base station to determine when to activate a respective instance of customer premises equipment in the supplemental support mode. In one embodiment, the module in the customer premises equipment determines any low performing UEs (based on Low MCQs) connected to the main wireless base station, locates and assesses how much of a load the UEs outside the subscriber domain are putting on the main wireless base station (i.e., top 25% low performing UEs that utilize 50% of the resources for example). After finding these UEs the, smart CPE relay looks instances of for CPE’s nearby and determines if switching wireless connectivity to any of those CPEs will improve the situation i.e., UEs will improve the MCQ performance.

After a smart CPE relay has determined the available CPEs, it or other suitable entity instructs a specific one or more candidate CPEs to run an iPerf client on it to determine if they can provide more throughput for the user equipment.

In further example embodiments, the network also needs to know how it can make use of GAA in addition to PAL wireless channels. This information could be obtained from SAS, FCC data base etc. i.e., what sites SAS has registered and spectrum allocations etc. stats and spectrum calculator will help in determining the clean GAA channel.

Before implementing operation of the customer premises equipment in a relay mode, the main wireless base station registers the selected CPE with the spectrum access system. This is only performed by the main wireless base station because the main wireless base station (a.k.a., network) already has all the credentials about the selected CPE. However, in one embodiment, the credentials are modified by the main wireless base station in order to operate the selected customer premises equipment in the relay mode. For example, some of the key SAS parameters are CbsdSerialNumber; Latitude; Longitude; Height; HeightType; IndoorDeployment; AntennaAzimuth; AntennaDowntilt; AntennaGain; AntennaBeamwidth.

Post SAS registration the EPC provides information such as security settings, limits on the number of users, and allocated bandwidth for the UEs through the CPE.

In further example embodiments, the customer premises equipment operates or appears as UE with respect to the main wireless base station and the mobile communication devices or UEs to be supported by the customer premises equipment operating in the relay mode. The operation is time synchronized is under the control of the EPC for transmission and scheduling purposes.

As further discussed herein, the selected CPE operating in the relay mode (supplemental wireless base station mode) can be configured to use any suitable protocol such as wireless communication protocol D2D to communicate with the UEs. After finding and selecting a desired customer premises equipment to operate in the relay mode, the main wireless base station or other suitable entity runs background checks and establishes virtual pipelines (data flows) to keep the traffics associated with its own communication devices in subscriber domain separate from data flows associated with communications from the one or more mobile communication devices outside the subscriber domain. This is done for various purposes such to keep the traffic separate and provide quality of service. i.e., not to degrade CPE’s performance.

In further example embodiments, the CPE can be configured to perform a scan of available GAA channels in a vicinity of the customer premises equipment to determine what channels have the lowest detected amount of use. In one embodiment, to expedite the scanning and determination of interference, the MME implements a calculator (a.k.a., CALC) to find sites nearby the mobile communication devices that need assistance provided by respective customer premises equipment. Based on nearby sites and running propagations, the MME will obtain a GAA channel for the wireless access point 121 in GAA. i.e., the cleanest available GAA channel.

Since there are multiple CPE’s in the network, the MME will need help from propagation tool, live statistics, etc., to determine the best possible customer premises equipment to provide the wireless connectivity to the corresponding mobile communication devices. In one embodiment, the selection of the customer premises equipment is based on multiple factors, i.e., location of the CPE, location of the UEs, SAS’s spectrum allocations, other operators, location of other operators as offenders.

The best instances of candidate customer premises equipment are selected and a corresponding GAA channel is requested from SAS. This request will also make SAS’s (spectrum access system) job easier in assigning channels as the calculations have already been done.

This process will be dynamic, i.e., as the load decreases the spectrum access system grant will be relinquished.

As load increases on one or more PAL channels, note that the EPC can decide to use a GAA channel (assuming that it is free of interference that the corresponding location where the customer premises equipment is implemented). This helps to load balance as well as improve a respective link budget.

In one embodiment, the wireless access point 121 implements D2D or other suitable wireless communication protocol to communicate with the UEs. Additional operation details are discussed below via communication flow 700.

In response to the wireless access point 121 receiving a command from the communication management resource 141 or other suitable entity to operate in the supplemental public wireless base station mode, via communications 710, the wireless access point 121 establishes connectivity through wireless base station 130-1 with a gateway (a.k.a., P-GW) of the communication management resource 141. The gateway P-GW provides the wireless access point 121 connectivity to a respective network such as the Internet, cellular network, etc.

Via communications 715, the wireless access point 121 receives notification to operate in a respective scan mode to determine usage of different wireless channels in a vicinity (such as one or more locations L1, L2, etc.) of the wireless access point 121. As previously discussed, during the scan mode, the wireless access point produces scan information 370 indicating the respective usage. The wireless access point communicates the scanned information 370 through the wireless base station 130-1 to the communication management resource 141.

Via communication 720, the combination of the MME and the CALC function associated with the communication management resource 141 selects an appropriate wireless channel for use by the wireless access point 121 to provide wireless connectivity to the mobile communication device 166. In one embodiment, the communication management resource 141 determines that wireless channel WCH12 is a good choice (because it is not used or used very little by other communication devices) in which to support communications between the wireless access point 121 and the mobile communication device 166. Accordingly, the communication management resource 141 selects wireless channel WCH12 as well as corresponding wireless access point 121 to communicate with the mobile communication device 166.

Via communications 730, the MME communicates with the allocation management resource 140 (such as spectrum access system) to provide appropriate parameters/settings for the wireless access point 121 to use one or more wireless channels. In one embodiment, as previously discussed, the allocation management resource 140 allocates the use of wireless channel WCH12 to the wireless access point 121 to communicate with the mobile communication device 166.

Via communications 740, before or after establishing the wireless connectivity 127-S between the wireless access point 121 and the mobile communication device 166, the wireless access point 121 repeatedly communicates heartbeat requests to the allocation management resource 140. The allocation management resource 140 (such as spectrum access system) repeatedly responds with grant communications to the wireless access point 121; the responses indicate that the wireless access point 121 is able to continue use of the previously allocated wireless channels.

Via communications 745, the wireless access point 121 communicates information about the mobile communication device 166 to the HSS. The HSS associated with the communication management resource 141 transfers the context of the mobile communication device 166 to the wireless access point 121.

Via communications 750, the MME notifies the wireless access point 121 that it is able to operate in the supplemental wireless base station mode to support connectivity with one or more mobile communication devices that are unable to communicate with or that are out of range with respect to the wireless base station 130-1. In one embodiment the transmitted communication settings (such as including D2D connectivity constraints) include information (such as wireless power transmit levels, wireless signal directivity, power step up control, number of allowable wireless connects to respective communication devices, etc.) controlling operation of the wireless access point 121 to communicate in the wireless network environment 100.

Subsequent to receiving the communication settings information from the MME, the wireless access point 121 establishes wireless connectivity 127-S between the wireless access point 121 and the mobile communication device 166. For example, via communications 655, the wireless access point 121 discovers presence of mobile communication device 166 such as via wireless communication protocol D2D or other suitable wireless communication protocol.

Via communications 760, the wireless access point 121 establishes a wireless connection (using wireless channel WCH12) with the mobile communication device 166 such as via D2D or other suitable wireless communication protocol.

Via communications 765 and 770 between the mobile communication device 166 and the wireless access point 130-1 and/or MME, the mobile communication device 166 receives a respective assigned network address and security information in order to set up a corresponding data path between the mobile communication device 166 and wireless access point 121 to the Gateway. For example, via communications 765, the mobile communication device 166 receives an IP network address to support connectivity with the wireless access point 121. Via communications 770, the mobile communication device 166 receives any encryption information to support secured communications with the wireless access point 121.

Via communications 775, the wireless access point 121 supports data flow setup between the mobile communication device 166 through the wireless access point 121 to the wireless base station 130-1.

Via communications 780, the wireless base station 130-1 provides notification of network address information and security information such as encryption information to the gateway.

Via communication 785, the mobile communication device 166 communicates uplink data through the wireless access point 121 and wireless base station 130-1 to the Gateway P-GW. In one embodiment, the Gateway forwards the uplink communications to the appropriate destination in the remote network 190. In a reverse direction, the Gateway receives communications from one or more entities in the network 190 and forwards them in the downlink direction through the wireless base station 130-1 and the wireless access point 121 to the mobile communication device 166.

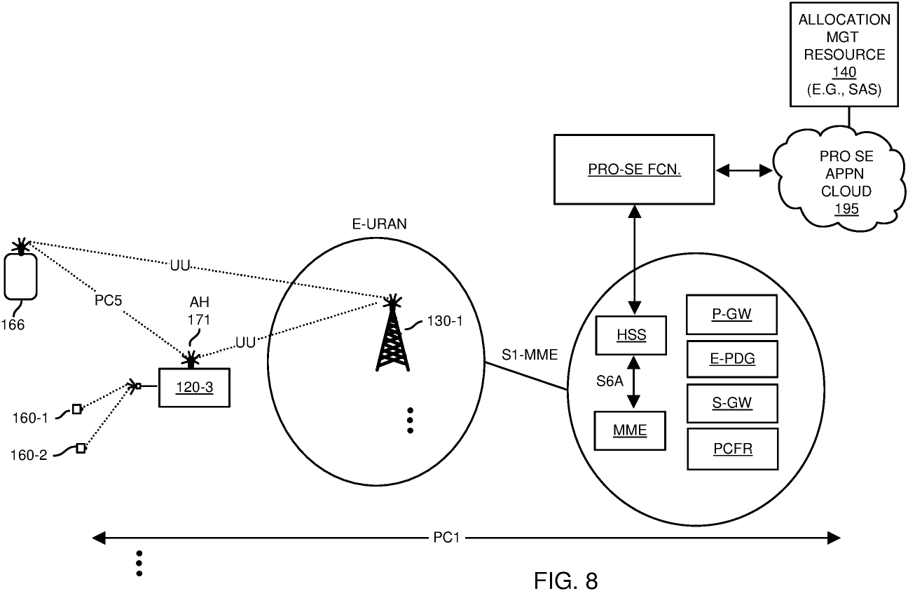

FIG. 8 is an example diagram of a network environment and implementation of customer premises equipment in a relay mode according to embodiments herein.

In this example embodiment, the EPC transfers the UE contexts of all the UEs identified by smart CPE relay function to CPE (wireless access point 121). The UE discovers the CPE and reports it back to the EPC, the EPC instructs the UE to move to the CPE via D2D connections.

There are multiple ways on how relay can communicate with the UEs and donor enodeB. Typical relaying operation will result in inefficient communication. D2D will let the CPE establish a separate stream of communication as shown in figure where the UE communicated with the CPE via PC5 interface.

The process is dynamic and grant from SAS is relinquished if resources aren’t needed anymore which results in termination of D2D connection. This is controlled by the EPC which continues to provide instructions on how to manage RF resources for the UEs.

ProSe provides the following parameters to the CPEs to enable connectivity with the UEs and assign unique IDs: Security parameters, Group IDs multicast addresses, Group ID multicast addresses and radio resource parameters

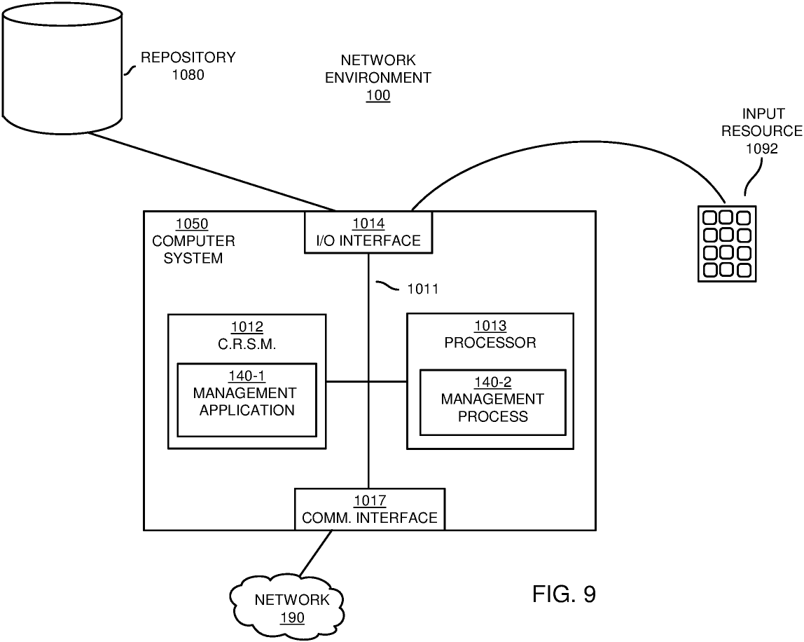

FIG. 9 is an example block diagram of a computer system for implementing any of the operations as previously discussed according to embodiments herein.

Note that any of the resources (such as wireless access point 121, mobile communication device 166, allocation management resource 140, communication management resource 141, mobile communication devices, user equipment, wireless stations, wireless base stations, communication management resource, control management resource, etc.) as discussed herein can be configured to include computer processor hardware and/or corresponding executable instructions to carry out the different operations as discussed herein.

For example, as shown, computer system 950 of the present example includes interconnect 911 coupling computer readable storage media 912 such as a non-transitory type of media (which can be any suitable type of hardware storage medium in which digital information can be stored and or retrieved), a processor 913 (computer processor hardware), I/O interface 914, and a communications interface 917.

I/O interface(s) 914 supports connectivity to repository 980 and input resource 992.

Computer readable storage medium 912 can be any hardware storage device such as memory, optical storage, hard drive, floppy disk, etc. In one embodiment, the computer readable storage medium 912 stores instructions and/or data.

As shown, computer readable storage media 912 can be encoded with management application 140-1 (e.g., including instructions) in a respective wireless station to carry out any of the operations as discussed herein.

During operation of one embodiment, processor 913 accesses computer readable storage media 912 via the use of interconnect 911 in order to launch, run, execute, interpret or otherwise perform the instructions in management application 140-1 stored on computer readable storage medium 912. Execution of the management application 140-1 produces management process 140-2 to carry out any of the operations and/or processes as discussed herein.

Those skilled in the art will understand that the computer system 950 can include other processes and/or software and hardware components, such as an operating system that controls allocation and use of hardware resources to execute the management application 140-1.

In accordance with different embodiments, note that computer system may reside in any of various types of devices, including, but not limited to, a mobile computer, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 950 may reside at any location or can be included in any suitable resource in any network environment to implement functionality as discussed herein.

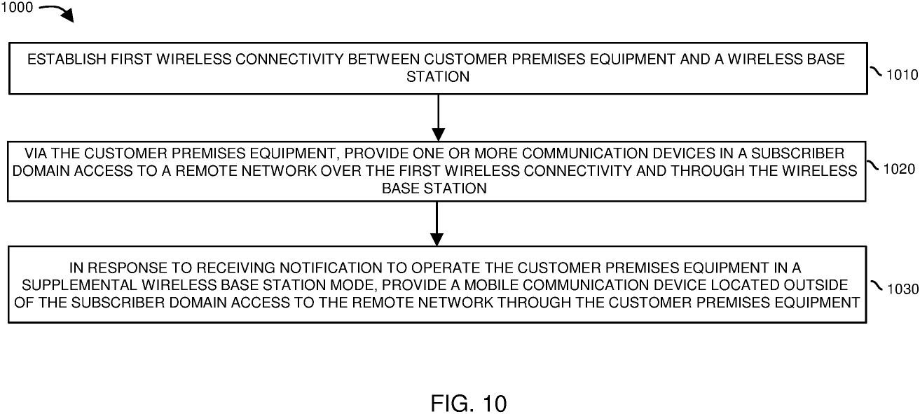

Functionality supported by the different resources will now be discussed via flowcharts in FIG. 10. Note that the steps in the flowcharts below can be executed in any suitable order.

FIG. 10 is a flowchart 1000 illustrating an example method according to embodiments herein. Note that there will be some overlap with respect to concepts as discussed above.

In processing operation 1010, the wireless station 121 (customer premises equipment) establishes first wireless connectivity between wireless base station 121 and the wireless base station 130-1.

In processing operation 1020, the wireless base station 121 provides one or more communication devices 161-1, 161-2, etc., in the subscriber domain 151 access to a remote network 190 over the first wireless connectivity 127-1 and through the wireless base station 130-1.

In processing operation 1030, in response to receiving notification to operate the wireless base station 121 in a supplemental wireless base station mode supporting wireless services to mobile communication devices unaffiliated with the subscriber domain 150-1, the wireless base station 121 provides a mobile communication device 166 located outside of the subscriber domain 150-1 access to the remote network 190 through the wireless base station 130-1.

Note again that techniques herein are well suited to provide mobile communication devices outside or unaffiliated with a subscriber domain access to a electromagnetic network (such as cellular network, Internet, etc.). However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

We claim:

1. A method comprising:
establishing first wireless connectivity between customer premises equipment and a wireless base station;
via the customer premises equipment, providing one or more communication devices in a subscriber domain access to a remote network over the first wireless connectivity and through the wireless base station; and
in response to receiving notification to operate the customer premises equipment in a supplemental wireless base station mode, providing a mobile communication device located outside of the subscriber domain access to the remote network through the customer premises equipment.

2. The method as in claim 1, wherein providing the mobile communication device access to the remote network through the customer premises equipment includes:
establishing second wireless connectivity between the customer premises equipment and the mobile communication device.

3. The method as in claim 2 further comprising:
receiving communications at the customer premises equipment over the first wireless connectivity from the wireless base station, the communications originating from the remote network; and
transmitting the communications from the customer premises equipment over the second wireless connectivity to the mobile communication device.

4. The method as in claim 1 further comprising:
monitoring a collective bandwidth service provided by the first wireless connectivity to the one or more communication devices in the subscriber domain; and
preventing the collective bandwidth service from falling below a threshold level.

5. The method as in claim 4, wherein preventing the collective bandwidth service from falling below the threshold level includes:
limiting an amount of wireless bandwidth over the first wireless connectivity supporting communications between the mobile communication device and the remote network through the customer premises equipment operating in the supplemental wireless base station mode.

6. The method as in claim 1 further comprising:
via the customer premises equipment, scanning use of wireless channels;
based on the scanning, detecting a degree of usage associated with the wireless channels;
receiving selection of a wireless channel from the wireless channels; and
via the selected wireless channel, establishing second wireless connectivity between the customer premises equipment and the mobile communication device to provide the mobile communication device access to the remote network over the first wireless connectivity.

7. The method as in claim 6 further comprising:
establishing a heartbeat channel between the customer premises equipment and a spectrum access system controlling use of the selected wireless channel; and
providing continued use of the selected wireless channel to support the second wireless connectivity in response to repeatedly receiving grant notifications from the spectrum access system allowing use of the second wireless connectivity by the customer premises equipment.

8. The method as in claim 7 further comprising:
receiving the grant notifications at the customer premises equipment from the spectrum access system over the first wireless connectivity.

9. The method as in claim 1 further comprising:
at the customer premises equipment, receiving communication control information over the first wireless connectivity from the wireless base station, the communication control information indicating to operate in the supplemental wireless base station mode via establishing second wireless connectivity between the customer premises equipment and the mobile communication device.

10. The method as in claim 9, wherein the communication control information specifies an identity of the mobile communication device in which to provide connectivity to the remote network via the second wireless connectivity and the first wireless connectivity.

11. The method as in claim 1, wherein the customer premises equipment is a fixed wireless access point providing the one or more communication devices in the subscriber domain and the mobile communication device access to the remote network over the first wireless connectivity.

12. The method as in claim 1, wherein the wireless base station initially supports a communication session between the wireless base station and the mobile communication device, the communication session including a control plane supporting conveyance of control information, the communication session including a first data plane supporting conveyance of data payload information, the control information controlling conveyance of the data payload information over the data plane, the method further comprising:
at the customer premises equipment, receiving a handoff of the first data plane from the wireless base station to the customer premises equipment.

13. The method as in claim 12 further comprising:
establishing second wireless connectivity between the customer premises equipment and the mobile communication device; and
wherein, subsequent to the handoff, the communication session with the mobile communication device is supported via: i) the control plane between the wireless base station and the mobile communication device, and ii) a second data plane supported via communications over the first wireless connectivity and the second wireless connectivity, the second data plane being a substitute of the first data plane to support the handoff.

14. A system comprising:
communication management hardware operative to:
establish first wireless connectivity between customer premises equipment and a wireless base station;
via the customer premises equipment, provide one or more communication devices in a subscriber domain access to a remote network over the first wireless connectivity and through the wireless base station; and
in response to receiving notification to operate the customer premises equipment in a supplemental wireless base station mode, providing a mobile communication device located outside of the subscriber domain access to the remote network through the customer premises equipment.

15. The system as in claim 14, wherein the communication management hardware is further operative to:
establish second wireless connectivity between the customer premises equipment and the mobile communication device.

16. The system as in claim 15, wherein the communication management hardware is further operative to:
receive communications at the customer premises equipment over the first wireless connectivity from the wireless base station, the communications originating from the remote network; and
transmit the communications from the customer premises equipment over the second wireless connectivity to the mobile communication device.

17. The system as in claim 14, wherein the communication management hardware is further operative to:
monitor a collective bandwidth service provided by the first wireless connectivity to the one or more communication devices in the subscriber domain; and
prevent the collective bandwidth service from falling below a threshold level.

18. The system as in claim 17, wherein the communication management hardware is further operative to:
limit an amount of wireless bandwidth over the first wireless connectivity supporting communications between the mobile communication device and the remote network through the customer premises equipment operating in the supplemental wireless base station mode.

19. The system as in claim 14, wherein the communication management hardware is further operative to:
via the customer premises equipment, scan use of wireless channels;
based on the scanning, detect a degree of usage associated with the wireless channels;
receive selection of a wireless channel from the wireless channels; and
via the selected wireless channel, establish second wireless connectivity between the customer premises equipment and the mobile communication device to provide the mobile communication device access to the remote network over the first wireless connectivity.

20. The system as in claim 19, wherein the communication management hardware is further operative to:
establish a heartbeat channel between the customer premises equipment and a spectrum access system controlling use of the selected wireless channel; and
provide continued use of the selected wireless channel to support the second wireless connectivity in response to repeatedly receiving grant notifications from the spectrum access system allowing use of the second wireless connectivity by the customer premises equipment.

21. The system as in claim 20, wherein the communication management hardware is further operative to:
receive the grant notifications at the customer premises equipment from the spectrum access system over the second wireless connectivity.

22. The system as in claim 14, wherein the communication management hardware is further operative to:
at the customer premises equipment, receive communication control information over the first wireless connectivity from the wireless base station, the communication control information indicating to operate in the supplemental wireless base station mode via establishing second wireless connectivity between the customer premises equipment and the mobile communication device.

23. The system as in claim 22, wherein the communication control information specifies an identity of the mobile communication device in which to provide connectivity to the remote network via the second wireless connectivity and the first wireless connectivity.

24. The system as in claim 14, wherein the customer premises equipment is a fixed wireless access point providing the one or more communication devices in the subscriber domain and the mobile communication device access to the remote network over the first wireless connectivity.

25. The system as in claim 14, wherein the wireless base station initially supports a communication session between the wireless base station and the mobile communication device, the communication session including a control plane supporting conveyance of control information, the communication session including a first data plane supporting conveyance of data payload information, the control information controlling conveyance of the data payload information over the data plane; and
wherein the communication management hardware is further operative to:
at the customer premises equipment, receiving a handoff of the first data plane from the wireless base station to the customer premises equipment.

26. The system as in claim 25, wherein the communication management hardware is further operative to: further comprising:
establish second wireless connectivity between the customer premises equipment and the mobile communication device; and
wherein, subsequent to the handoff, the communication session with the mobile communication device is supported via: i) the control plane between the wireless base station and the mobile communication device, and ii) a second data plane supported via communications over the first wireless connectivity and the second wireless connectivity, the second data plane being a substitute of the first data plane to support the handoff.

27. Computer-readable storage hardware having instructions stored thereon, the instructions, when carried out by computer processor hardware associated with customer premises equipment in a wireless network, cause the computer processor hardware to:
establish first wireless connectivity between the customer premises equipment and a wireless base station;
providing one or more communication devices in a subscriber domain access to a remote network over the first wireless connectivity and through the wireless base station; and
in response to receiving notification to operate the customer premises equipment in a supplemental wireless base station mode, providing a mobile communication device located outside of the subscriber domain access to the remote network through the customer premises equipment.
